(19) United States
(12) Patent Application Publication
(10) Pub. No.: US 2006/0266013 A1
(43) Pub. Date: Nov. 30, 2006

(54) Ventilator and method for making the same

(75) Inventors: Yung-Chuan Tseng, Miao Li County (TW); Kuo-Wen Chen, Miao Li County (TW)

Correspondence Address: LADAS & PARRY;Suite 2100, 5670 Wilshire Boulevard, Los Angeles, CA, 90036-5679, US

(73) Assignee: CORETRONIC CORPORATION

(21) Appl. No.: 11/437,202

(22) Filed: May 18, 2006

(30) Foreign Application Priority Data
May 24, 2005 (TW) 094116869

(51) Int. Cl. B01D 46/00

(52) U.S. Cl. 55/486

(57) ABSTRACT

A ventilator includes a frame, a filtering layer, and a bonding member. The frame defines a receiving space and at least one through hole communicating with the receiving space. The filtering layer is positioned in the receiving space of the frame. The bonding member is disposed between the frame and the filtering layer, and is heat fusible to bind the filtering layer to the frame.

### CROSS-REFERENCE TO RELATED APPLICATION

This application claims priority of Taiwanese Application No. 094116869, filed on May 24, 2005.

### BACKGROUND OF THE INVENTION

1. Field of the Invention

The invention relates to a ventilator, more particularly to a ventilator for a display device.

2. Description of the Related Art

Conventionally, a ventilator of a heat dissipating unit for a display device is usually made by forming a plurality of through holes in a casing of the display device. Heat produced in the display device can be dissipated via the through holes. However, dust or particles may enter the display device via the through holes and adhere on internal components of the display device, which may adversely affect the operation of the display device.

Referring to FIG. 1, a conventional solution to the aforesaid problem is to mount a ventilating structure 1 including a frame 11 and a filtering layer 12 on a casing 2 to cover a plurality of ventilating slots 21 defined in the casing 2. The frame 11 defines a receiving space 111 and has a plurality of through holes 112 fluidly communicating with the receiving space 111. The filtering layer 12 is made of sponge, and is disposed in the receiving space 111 of the frame 11. Therefore, dust or particles entering via the ventilating slots 21 can be blocked by the filtering layer 12. However, the dust or particles adhered on the sponge filtering layer 12 are not easy to remove by washing. Referring to FIGS. 2 and 3, conventionally, the filtering layer 12 is bound to the frame 11 using a bonding member, of which two examples are a double-sided adhesive tape 13 and a retaining member 14. However, the double-sided adhesive tape 13 is liable to adhere the dust or particles thereon, which are difficult to remove. On the other hand, the introduction of the retaining member 14 complicates the assembly procedure and increases the production cost. Furthermore, satisfactory binding effect cannot be achieved through the aforesaid conventional binding manners.

### SUMMARY OF THE INVENTION

Therefore, one object of the present invention is to provide a ventilator which can ease the manufacture procedure and reduce the manufacture cost.

Another object of this invention is to provide a ventilator which is easier to be cleaned.

In one aspect of this invention, a ventilator includes a frame defining a receiving space and at least one through hole communicating with the receiving space, a filtering layer positioned in the receiving space of the frame, and a bonding member disposed between the frame and the filtering layer and being heat fusible to bind the filtering layer to the frame.

In another aspect of this invention, a method for making a ventilator includes the steps of: mounting a heat fusible bonding member on a frame; positioning a filtering layer on the frame such that the filtering layer is in contact with the heat fusible bonding member; and melting the heat fusible bonding member so as to bind the filtering layer to the frame.

### BRIEF DESCRIPTION OF THE DRAWINGS

Other features and advantages of the present invention will become apparent in the following detailed description of the preferred embodiments with reference to the accompanying drawings, of which:

FIG. 1 is an exploded perspective view of a conventional ventilating structure to be mounted on a casing;

FIG. 2 is a fragmentary exploded perspective view of a conventional ventilating structure showing a bonding member to bind a filtering layer to a frame;

FIG. 3 is a fragmentary exploded perspective view of another conventional ventilating structure showing a bonding member to bind a filtering layer to a frame;

FIG. 4 is a sectional view of a preferred embodiment of a ventilator according to this invention;

FIG. 5 is a flow diagram of a preferred embodiment of a method for making a ventilator according to this invention; and

FIG. 6 is an exploded schematic sectional view to illustrate the method for making the ventilator of the preferred embodiment.

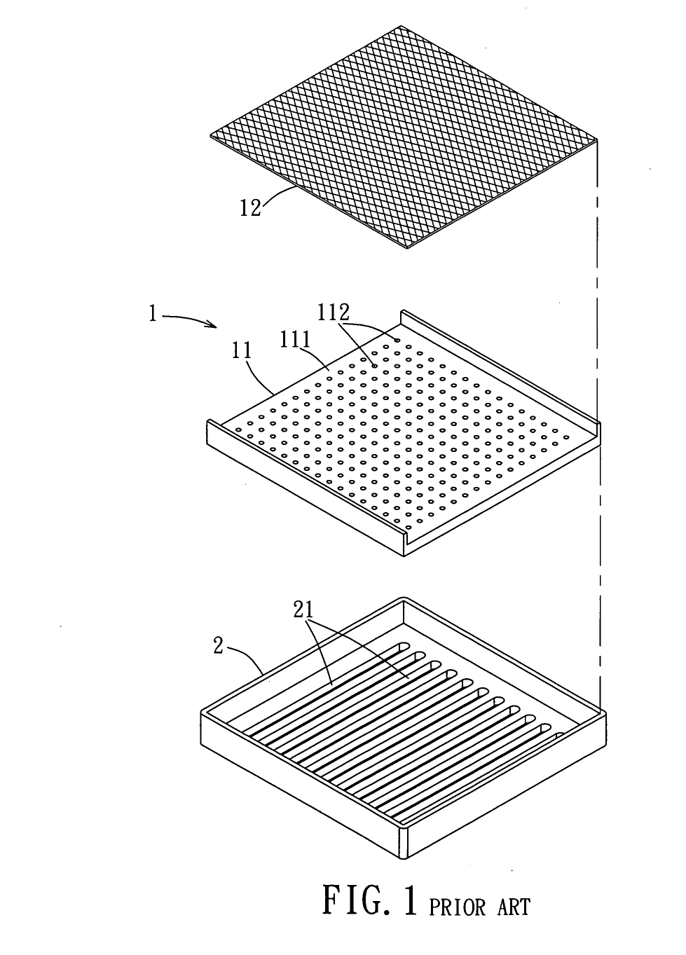

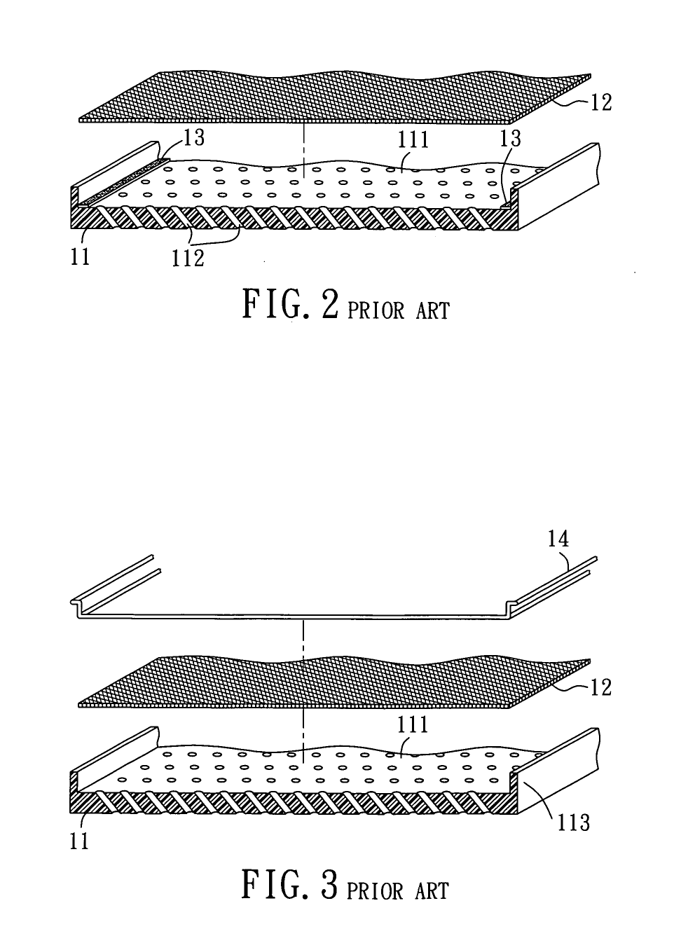

### DETAILED DESCRIPTION OF THE PREFERRED EMBODIMENTS

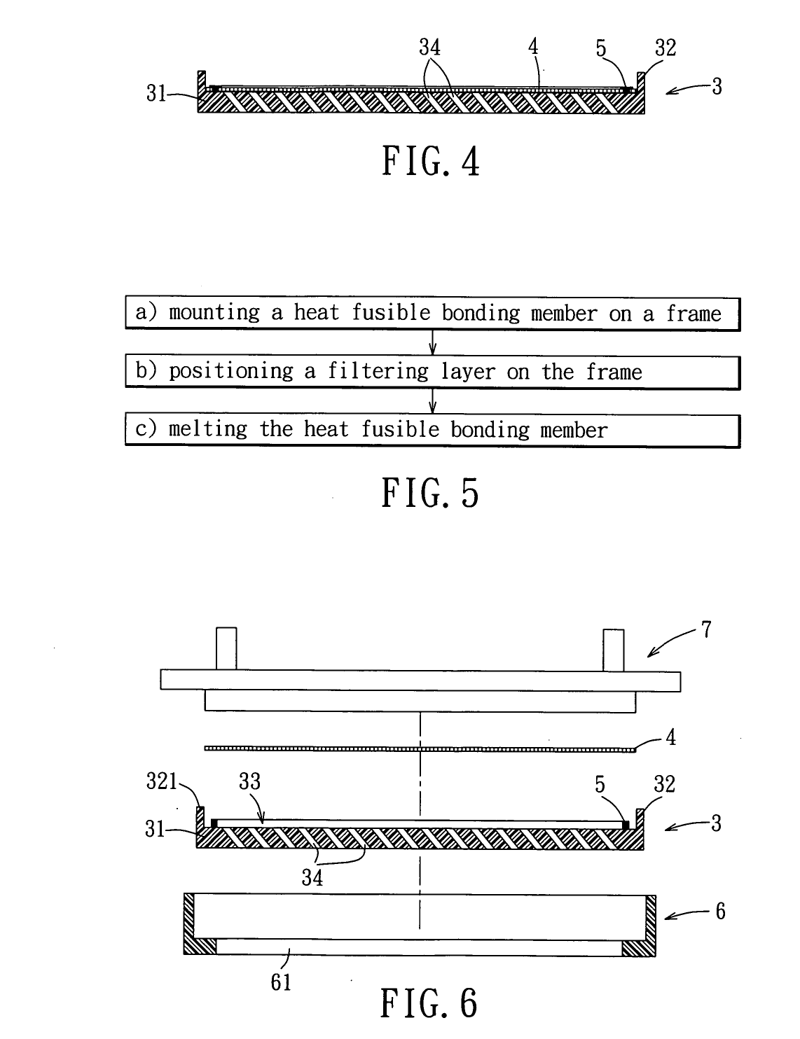

Referring to FIGS. 4 and 6, the preferred embodiment of a ventilator according to this invention is shown to be adapted for installation on a casing 6 of a display device, such as a rear-projection TV. The casing 6 has a plurality of ventilating slots 61 (only one is shown). The ventilator includes a frame 3, a filtering layer 4, and a bonding member 5.

The frame 3 includes a base plate 31 formed with a plurality of through holes 34 therein, and a supporting wall 32 having supporting wall portions 321 that extend peripherally from the base plate 31 to define a receiving space 33. The through holes 34 are in communication with the receiving space 33, respectively.

The filtering layer 4 is positioned in the receiving space 33 of the frame 3, and is mounted on the base plate 31 of the frame 3 for blocking dust or particles from entering the display device via the ventilating slots 61 of the casing 6. The filtering layer 4 is a netted structure made of a kind of heat-resistant plastic or a kind of metal. Therefore, it is relatively easy to clean the filtering layer 4 by washing or vacuuming.

The bonding member 5 is heat fusible and is disposed between the frame 3 and the filtering layer 4. The bonding member 5 penetrates the netted structure of the filtering layer 4 after being fused so as to bind the filtering layer 4 to the frame 3. The bonding member 5 is a rib made of heat fusible bonding material and extending upwardly from a periphery of the filtering layer 4 near the supporting wall 32. The heat fusible bonding material suitable in this invention may be a kind of heat fusible adhesive or a kind of welding metal.

Referring to FIGS. 5 and 6, the preferred embodiment of a method for making the ventilator includes the steps of: a) mounting the heat fusible bonding member 5 on the frame 3; b) positioning the filtering layer 4 on the frame 3 such that the filtering layer 4 is in contact with the heat fusible bonding member 5; and c) melting the heat fusible bonding member 5 so as to bind the filtering layer 4 to the frame 3. The step c) is conducted using a welding tool 7 to press the filtering layer 4 against the heat fusible bonding member 5 and the frame 3 at a heating temperature.

In summary, in the ventilator of this invention, the filtering layer 4 is bound to the frame 3 using the heat fusible bonding member 5. Therefore, the binding strength between the filtering layer 4 and the frame 3 is improved. Furthermore, the aforesaid shortcomings encountered in the prior arts can be overcome. Dust and particles entering via the ventilating slots 61 in the casing 6 would not adhere to the bonding member 5. Since the manufacture procedure is easier than that of the prior art shown in FIG. 3 in which the retaining member 14 is used, the manufacture cost is reduced as well.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

We claim:

1. A ventilator, comprising:
a frame defining a receiving space and at least one through hole communicating with said receiving space;
a filtering layer positioned in said receiving space of said frame; and
a bonding member disposed between said frame and said filtering layer and being heat fusible to bind said filtering layer to said frame.

2. The ventilator as claimed in claim 1, wherein said filtering layer is a netted structure made of a kind of heat-resistant plastic or a kind of metal, said bonding member penetrating said netted structure after being fused.

3. The ventilator as claimed in claim 2, wherein said bonding member is a rib made of heat fusible bonding material and extending upwardly from a periphery of said filtering layer.

4. The ventilator as claimed in claim 3, wherein said heat fusible bonding material is a kind of heat fusible adhesive.

5. The ventilator as claimed in claim 3, wherein said heat fusible bonding material is a kind of welding metal.

6. The ventilator as claimed in claim 1, wherein said frame includes a base plate with said at least one through hole formed therein, and a supporting wall extending peripherally from said base plate to define said receiving space.

7. The ventilator as claimed in claim 6, wherein said filtering layer is bound to said base plate of said frame by said bonding member.

8. A method for making a ventilator, comprising the steps of:
a) mounting a heat fusible bonding member on a frame;
b) positioning a filtering layer on the frame such that the filtering layer is in contact with the heat fusible bonding member; and
c) melting the heat fusible bonding member so as to bind the filtering layer to the frame.

9. The method as claimed in claim 8, wherein the step
c) is conducted using a welding tool by pressing the filtering layer against the heat fusible bonding member and the frame at a heating temperature.

10. The method as claimed in claim 8, wherein the heat fusible bonding member is a kind of heat fusible adhesive.

11. The method as claimed in claim 8, wherein the heat fusible bonding member is a kind of welding metal.

12. The method as claimed in claim 8, wherein the filtering layer is a netted structure.

13. The method as claimed in claim 8, wherein the bonding member is a rib made of heat fusible bonding material and extending upwardly from a periphery of the filtering layer.

14. The method as claimed in claim 13, wherein the heat fusible bonding material is a kind of heat fusible adhesive.

15. The method as claimed in claim 13, wherein the heat fusible bonding material is a kind of welding metal.
